(19) United States
(12) Patent Application Publication
(10) Pub. No.: US 2010/0102951 A1
(43) Pub. Date: Apr. 29, 2010

(54) Sharing of a Neighboring Wireless Network

(75) Inventor: Mark Rutledge, Murrieta, CA (US)

Correspondence Address: FISH & ASSOCIATES, PC;ROBERT D. FISH, 2603 Main Street, Suite 1000, Irvine, CA, 92614-6232, US

(73) Assignee: DEI HOLDINGS, INC., Vista, CA (US)

(21) Appl. No.: 12/260,339

(22) Filed: Oct. 29, 2008

(51) Int. Cl. G08B 29/00; G08B 13/00

(52) U.S. Cl. 340/507; 340/508

(57) ABSTRACT

A security system can detect if a first network is compromised and automatically access a second network to communicate an alert to a monitor. The second network could be a wireless network of a neighbor. An incentive could be provided to the neighbor to allow the security system to access the neighbor's network and communicate an alert to at least one monitor. The monitor could include an emergency responder, a security monitoring service, and a cellular telephone of an entity of the security system.

### FIELD OF THE INVENTION

The field of the invention is emergency or alarm communications.

### BACKGROUND

Security systems in a home, office or other building traditionally use a telephone line to communicate to a monitor about a triggering event. Such systems can often be compromised by simply cutting the telephone line to the security system before triggering the security system. Thus, while the security system would be alerted to the event, the system would not be able to communicate the event to the monitor because of the compromised line.

Security systems are known that can connect to a second telephone line if the first line is compromised. One problem with that configuration, however, is that the second line can generally also be compromised. Use of a cable connection might be somewhat safer because the cables tend to be buried in the ground, but such connections can still be compromised. Thus, as long as a security system uses hard wiring, whether copper or fiber or anything else, the system can be rendered ineffective by simply cutting the line.

One solution has been to use a power line to communicate a potential security problem from a security system to a neighboring residence. For example, U.S. Pat. No. 7,339,466 to Mansfield is known to teach a system that relays an event to a neighboring residence if the telephone line is compromised. The neighboring residence can then communicate the event to a monitor. One problem with this configuration is that it requires the neighboring residence to have a cooperating security system, and requires the neighboring residence to allow the first residence to use its telephone line.

Mansfield and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a security system that can detect if a first network is compromised and automatically connect to a neighboring network. Furthermore, there is still a need for a system that facilitates obtaining access to the neighboring network.

### SUMMARY OF THE INVENTION

In one aspect, the inventive subject matter provides apparatus, systems and methods in which a system can detect a compromised status of a first network, and automatically connect to a neighboring network.

In preferred embodiments, the system is a security system that uses a first network to communicate with a remote monitor, perhaps at a security monitoring service, a police station or other emergency responder, or a cellular telephone.

All manner of detectors are contemplated to determine whether the network is compromised. Contemplated detectors include software that monitors Internet connectivity through a land line or cable.

Both the first and neighboring networks likely need to have wireless capability. But otherwise the two networks could be entirely independent from one another.

While alerts can be as simple as an address or other short text message, it is also contemplated that alerts could also include a video component, an audio component, and a status of the security system.

Although neighbors might communicate directly with each other to coordinate their networks as contemplated herein, it may well be advantageous for a telephone, power, security or other utility company to facilitate that communication. For example, a monitoring company could provide an incentive to one family to allow a neighbor's access to their wireless network. All manner of incentives are contemplated, including especially a monetary incentive or discount in the monthly service fee.

Once a neighbor has agreed to allow access to its wireless network, appropriate software can be installed on both networks to facilitate the fail-over connection. Preferably, that software limits access in some way, so that the neighbor's network is used only to communicate the alert, and not to access private data.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIGS. 1a-1c are schematics of a security system that automatically detects a compromised first network and accesses a neighboring network.

FIG. 2 is a flowchart of a method of providing a backup to a security system.

FIG. 3 is a flowchart of contemplated steps in facilitating a fail-over connection of the security system.

### DETAILED DESCRIPTION

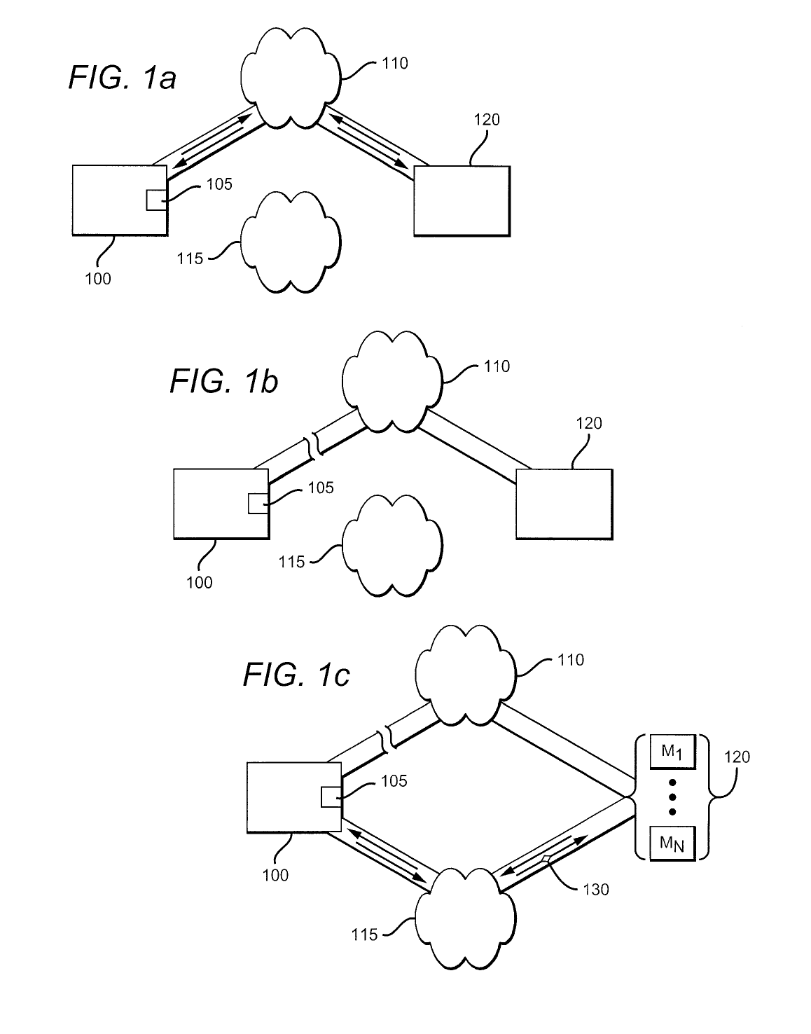

In FIGS. 1a-1c a security system 100 generally includes a detector 105 that can detect when a first network 110 is compromised.

In FIG. 1a, the security system 100 can connect to the first network 110 and communicate with a monitor 120. All manner of connections are contemplated, including hard-wired telephone and cable connections, and satellite, cellular or other wireless connections.

Monitor 120 preferably is a security monitoring service, but could also, for example, be an emergency responder, a website, a software program, a municipality, or a cellular telephone authenticated by the security system. The key factor is that the alert is communicated to a remote site from which appropriate action can be taken. At one extreme that action might be simply calling someone at the breached site to verify the alert, and at another extreme might involve sending a patrol car to the scene.

FIG. 1b illustrates the detector 105, which determines whether the first network 110 is compromised. Detector 105 could be software based, hardware based, or could have any combination of the two. In most instances a software detector is probably adequate, and is desirable because the marginal cost per installation is close to zero. Detectors most likely would be installed to detect any of multiple alert conditions, including for example a power outage, a line failure, an intentional destruction of the line, an equipment failure, and a bottleneck in the network.

During a time period in which the first network 110 is compromised, the security system 100 is preferably configured to automatically access a second network 115 to communicate an alert 130 to at least one monitor 120, as shown in FIG. 1c. Unless a contrary intent is apparent from the context, all ranges recited herein are inclusive of their endpoints, and open-ended ranges should be interpreted to include only commercially practical values. In especially preferred embodiments, the security system is configured to communicate with at least two monitors 120, which might for example be to a cell phone of the owner of a house, and to a monitor at the security service.

The second network 115 is preferably a wireless network controlled by a neighbor, but could be any sort of community network that is not directly controlled by a neighbor, for example an Internet network for an entire apartment building, a city-wide Internet network, or a cellular network. The neighbors need not be the same type of entities. For example, a security system for a house might use the wireless network of nearby Starbucks™ coffee shop. A security system in a building might use the wireless network of a nearby government agency. The networks need to be compatible in some manner, but certainly do not need to be mirror images. Thus, a household security system might communicate over 802.11b, while the neighbor might use 802.11g.

Alert 130 is any communication capable of informing a monitor of a possible emergency situation. All suitable contents are contemplated, including for example, location information, and a status of the corresponding security system. All suitable presentations of the information are also contemplated. For example, alerts be transmitted as a text message, and can additionally or alternatively be presented as icons, video or still images, audio, etc.

By including additional information in alert 130, remote monitor 120 has a better understanding of a situation and can respond appropriately. For example, a security monitoring service receiving alert 130 might learn of the compromised first network 10, view video of an in-progress burglary at a site, and notify the police. A security monitoring service might listen to audio from a site, view an all-clear status of security system 100, and notify maintenance to fix the network. Thus, alert 130 allows a monitor 120 to more efficiently evaluate a situation.

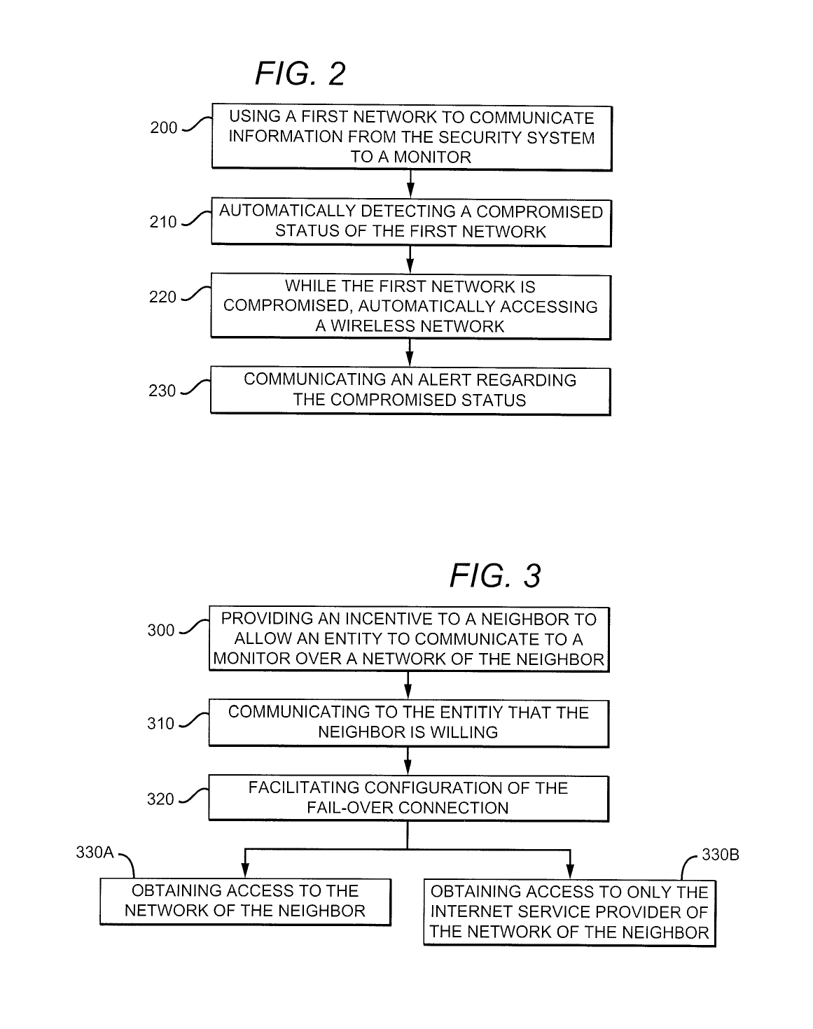

FIG. 2 depicts a method of providing a backup to a security system. Initially, a first network is used to communicate information from the security system to a monitor 200. The security system can automatically detect if the first network is compromised 210. If the first network becomes compromised, a wireless network is automatically accessed 220, and an alert regarding the compromised status is communicated 230. This is advantageous as the backup network enables the security system to communicate the alert to a monitor. Without such backup, for example, the security system might be rendered ineffective.

FIG. 3 depicts a method for facilitating a fail-over connection for a security system using a neighbor's network. Initially, a telephone, power, security or other utility company provides an incentive to the neighbor for allowing access to the neighbor's network 300. All manner of incentives are contemplated, including especially a monetary incentive or discount in the monthly telephone, Internet connection, cable, power or other service fee.

Once access to the neighbor's network has been arranged, the company communicates that the neighbor is willing 310 and facilitates configuration of the security system's fail-over connection 320. The network can be configured using a variety of methods, including a web interface, an API interface, a programming interface, and loading a software module on the network. For example, the company might load a first software module on the security system, and a different software module on the network hardware, to configure and facilitate the fail-over connection for the security system.

Once configured, the security system can access the neighbor's network 330A. In a preferred configuration, the neighbor's network limits the security system's access to only an Internet communication 330B. This is especially advantageous as it balances the security system's need to communicate an alert with the neighbor's need to protect the privacy of the neighbor's personal and confidential information.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a backup to a security system, the method comprising:
using a first network to communicate information from the security system to a monitor;
automatically detecting a compromised status of the first network; and
while the first network is compromised, automatically accessing a wireless network and communicating an alert regarding the compromised status.

2. The method of claim 1, further comprising a utility giving an incentive for access to the wireless network by the security system.

3. The method of claim 2, wherein the incentive is monetary.

4. The method of claim 1, where the method further comprises communicating the alert to the monitor.

5. The method of claim 1, wherein the alert further comprises a video component.

6. The method of claim 1, wherein the alert further comprises an audio component.

7. The method of claim 1, wherein the alert further comprises a status of the security system.

8. The method of claim 1, wherein the monitor is selected from a list consisting of a security monitoring service, an emergency responder, and a cell phone authenticated by the security system.

9. A method for facilitating a fail-over connection of a security system of an entity to a neighbor, comprising:
providing an incentive to the neighbor to allow the entity to communicate to a monitor over a network of the neighbor;
communicating to the entity that the neighbor is willing; and
facilitating configuration of the fail-over connection.

10. The method of claim 9, further comprising sending a software to the entity.

11. The method of claim 9, further comprising obtaining access to the network of the neighbor.

12. The method of claim 9, further comprising configuring the network of the neighbor to provide the entity access to an internet service provider only.

13. A device for providing a backup to a security system, comprising a computer that operates a software programmed to do the following:
detect a compromised status of a first network;
detect a second network of a neighbor; and
pass an alert through the second network of the neighbor to a monitor regarding the compromised status of the first network.
